(19) United States
(12) Patent Application Publication
(10) Pub. No.: US 2011/0027767 A1
(43) Pub. Date: Feb. 3, 2011

(54) Anthropomorphic mannequin

(76) Inventor: Glenn J. Divinagracia, Hagerstown, MD (US)

Correspondence Address: LITMAN LAW OFFICES, LTD., PATENT LAW BUILDING, 8955 CENTER STREET, MANASSAS, VA, 20110, US

(21) Appl. No.: 12/805,386

(22) Filed: Jul. 28, 2010

Related U.S. Application Data
(60) Provisional application No. 61/213,923, filed on Jul. 29, 2009.

(51) Int. Cl. G09B 23/30

(52) U.S. Cl. 434/274

(57) ABSTRACT

The anthropomorphic mannequin includes a skeletal portion made from relatively hard, rigid material, organ and muscle portions made from softer, compressible, and extensible materials, and a skin portion made from compressible and extensible materials. Extensible materials are attached to a core structure and distributed in middle and outer layers of the anthropomorphic model and connect skeletal members to simulate the movement and feel of soft tissue and muscles across the joints. An elastic cord connected across the joints produces a life-like feel to the touch. The anthropomorphic mannequin allows flexion, extension, side bending, and rotation at appropriate joints to simulate human joint movement. The mannequin provides a training dummy for those who have to physically manipulate a human patient.

### CROSS-REFERENCE TO RELATED APPLICATION

This application claims the benefit of U.S. Provisional Patent Application Ser. No. 61/213,923, filed Jul. 29, 2009.

### BACKGROUND OF THE INVENTION

1. Field of the Invention

The present invention relates generally to human anatomical models and training dummies, and particularly to an anthropomorphic mannequin that can be used for training physical therapists, occupational therapists, registered and practical nurses, X-ray technicians, orderlies, and others involved in physically handling patients.

2. Description of the Related Art

Medical personnel, especially those working in the field of emergency medicine, physical therapy, and the like, are often required to position, manipulate, and otherwise move patients in order to prep them for some diagnostic procedure, or to prep them for treatment of diseases, bone disorders, and the like.

Unfortunately, training of medical personnel in handling methods of patients has been severely limited because such training has usually been restricted to experience gained through manipulation and handling of actual living patients. Naturally, one cannot choose the number and frequency of such patients or the types and degrees of their respective maladies. Consequently, training through actual experience has proven to be sporadic at best and generally limited.

There is a need for a realistic device for training medical personnel in the manipulation and handling of the human body.

Thus, an anthropomorphic mannequin solving the aforementioned problems is desired.

### SUMMARY OF THE INVENTION

The anthropomorphic mannequin includes a skeletal portion made from relatively hard or rigid material, organ and muscle portions made softer, compressible, and extensible materials, and a skin portion made from compressible and extensible materials. Extensible materials are attached to a core structure and distributed in middle and outer layers of the anthropomorphic model and connect skeletal members to simulate the movement and feel of soft tissue and muscles across the joints. An elastic cord connected across the joints produces a life-like feel to the touch. Anatomical accuracy is provided, and the anthropomorphic mannequin allows flexion, extension, side bending, and rotation at appropriate joints to simulate human joint movement. The shoulder joint of the form mimics the scapulothoracic and glenohumeral joint movements of an actual human subject. Extensible material is attached to the trunk and limbs to allow the form to partially assist leg straightening, torso extension and straightening, and shoulder depression and adduction.

These and other features of the present invention will become readily apparent upon further review of the following specification and drawings.

### BRIEF DESCRIPTION OF THE DRAWINGS

FIG. 1 is an environmental, perspective view of an anthropomorphic mannequin according to the present invention, shown in a seated position.

FIG. 2 is an environmental, perspective view of the anthropomorphic mannequin according to the present invention, shown in a prone position.

FIG. 3 is a rear, perspective view of an anthropomorphic mannequin according to the present invention, shown with the head and skin removed to show the internal structure of the mannequin.

FIG. 4 is a partial front view of the internal structure of the torso portion of an anthropomorphic mannequin according to the present invention.

FIG. 5 is a partial front view of an anthropomorphic mannequin according to the present invention, the skin or outer covering being removed from the pelvis and legs to show details thereof.

FIG. 6 is a partial front view of an anthropomorphic mannequin according to the present invention, showing soft resilient wrapping being applied to legs.

FIG. 7 is a partial front perspective view of an anthropomorphic mannequin according to the present invention, showing a hand with the skin covering removed to show details thereof.

Similar reference characters denote corresponding features consistently throughout the attached drawings.

### DETAILED DESCRIPTION OF THE PREFERRED EMBODIMENTS

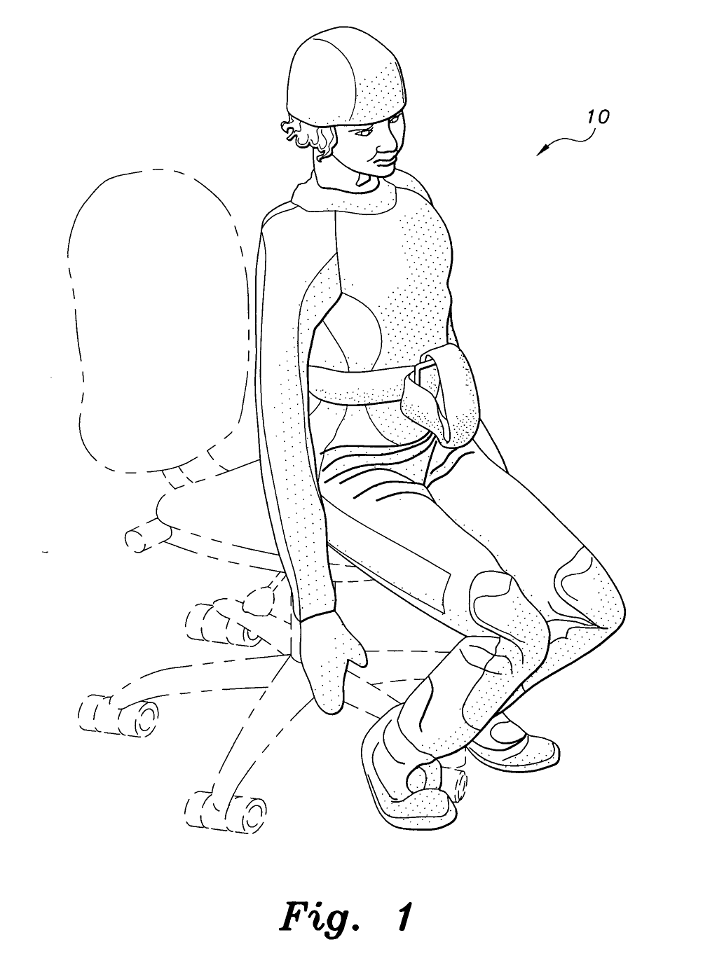

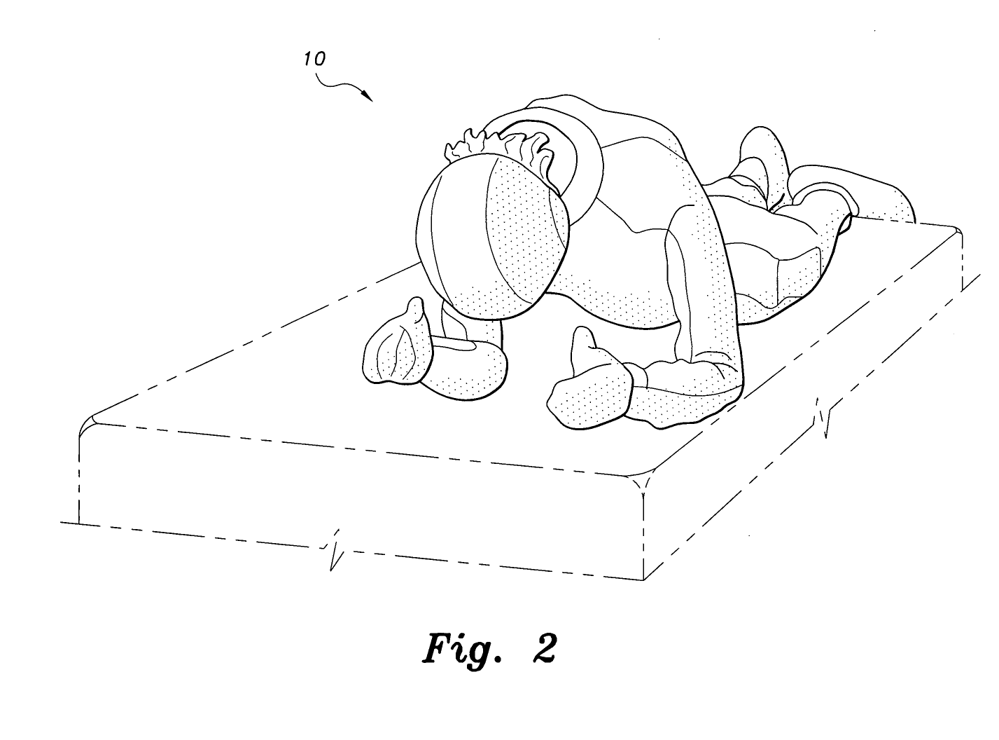

The anthropomorphic mannequin is a training dummy that includes a skeletal portion made from relatively hard or rigid material, organ and muscle portions made from softer compressible and extensible materials, and a skin portion comprising compressible and extensible material. As shown in FIGS. 1 and 2, the mannequin 10 can be positioned in a variety of postures that a therapist or health care practitioner may be expected to encounter in a real patient. Extensible materials are attached to a core structure and distributed in middle and outer layers of the anthropomorphic mannequin and across joints to simulate the presence and feel of soft tissue and muscle tension across the joints.

For example, a plurality of elastic or extensible cords connect skeletal-simulation members across joints to produce life-like movement and feel when a user touches or adjusts a limb. Anatomical accuracy is provided and the anthropomorphic mannequin allows flexion, extension, side bending, and rotation at appropriate joints to simulate human joint movement. For example, the shoulder joint of mannequin 10 mimics the scapulothoracic and glenohumeral joint movements of an actual human subject. Extensible or elastic material is attached to the trunk and limbs to allow the form to partially assist leg straightening, torso extension and straightening, and shoulder depression and adduction.

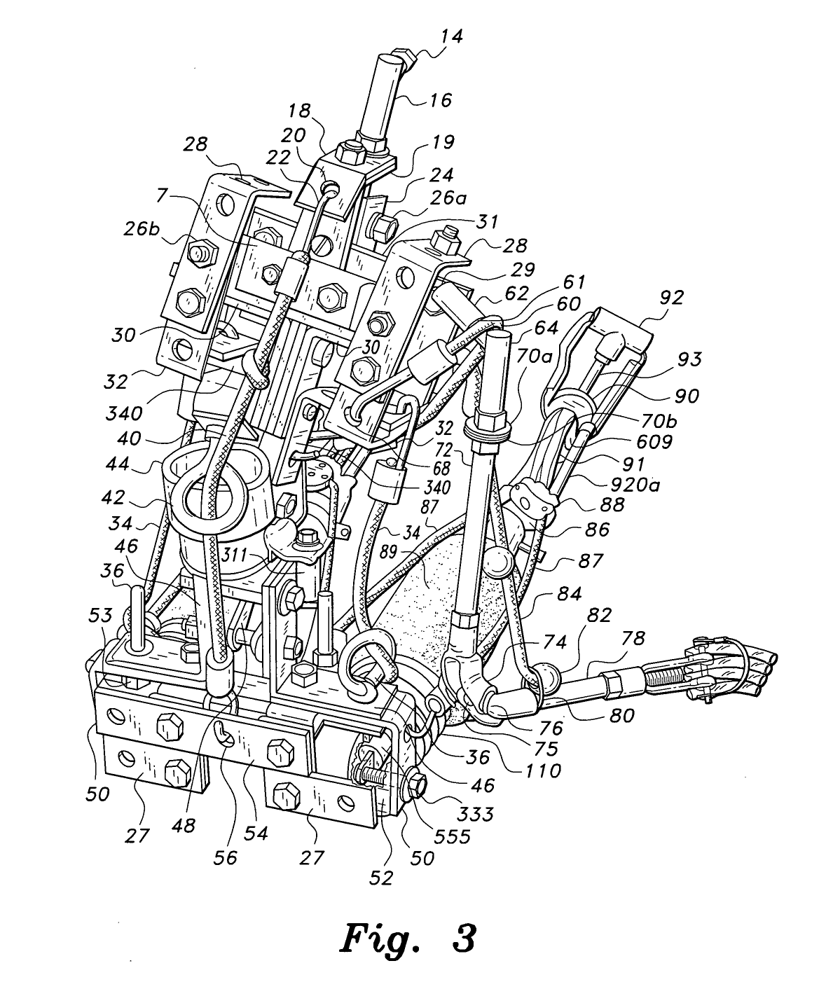

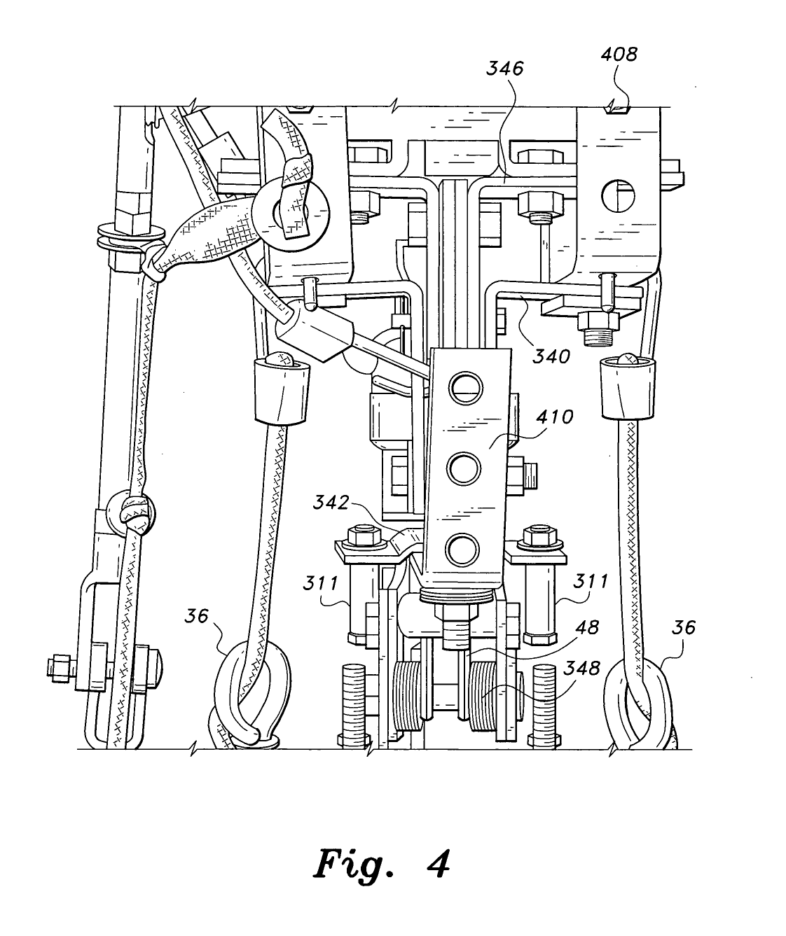

As shown in FIGS. 3 and 4, a number of support structures, such as upper back-shoulder inverted-L bracket 28, thoracic upright L-bracket 30, anterior chest horizontal bracket 31, posterior horizontal rib bracket 7, lower posterior rib L-brackets 32, thoracolumbar L-bracket 340, short upper lumbar L-bracket 46, posterior superior pelvic bracket 50, thoracolumbar L-bracket 340, thoracolumbar U-bracket 342, mid-thoracic L-bracket 346, lumbar bent clevis spacers 348, nipple chest fastener 408, abdominal L-bracket 410, and horizontal bracket 54 supported by left and right lower lumbar support plates 27 are interconnected using nuts 26b and bolts 26a to provide a simulated effect of analogous structures found in the human body. An elongate cylindrical lumbar rotation stop 311 limits the degree to which the lumbar components can rotate about the central median axis of the mannequin 10. Additionally, posterior thoracic tunnel 44, which is formed by a hollow, tubular, resilient body, provides resilient support in the thoracic region.

With respect to simulation of human neck physiology, an anterior superior neck nut 14 extends at a right angle from a vertically extending neck member 16. Neck member 16 extends from neck extensor 45° bracket 18, which is connected to cervical-thoracic L-bracket 19. The cervical-thoracic L-bracket 19 serves the purpose of simulating the cervical and thoracic region of an actual person. Neck extensor 45° bracket 18 has a neck extensor tensioner hook-receiving hole 20, which receives a midline posterior elastic cord fastener 22, thereby fastening posterior elastic cord 40 to the neck. The opposite end of the posterior elastic cord 40 is fastened to the horizontal bracket 54 at a lower midline back extensor cord-retaining hole 56. The middle portion of the posterior elastic cord 40 is threaded through a posterior thoracic ring 42, which is held in place by a bracket attached to lower portion of upper back-shoulder inverted L-bracket 28. The neck 16 can be manipulated forward under tension applied by the posterior elastic cord 40, but just as in a real patient, forward neck pivoting is limited. In the device 10, neck pivot limiting is effected by contact of the cervical-thoracic L-bracket 19 with a lower cervical extension stop bar 24.

For each of L-brackets 28, a scapulothoracic ball joint 29 is attached to the upper portion of the upper back-shoulder inverted L-bracket 28, thereby simulating the left and right scapulothoracic joints in a real person. An elongate, cylindrical member 62 extends from the ball joint 29 and is pivotally attached to cylindrical lateral shoulder member 64. The pivotal attachment of lateral shoulder member 64 to cylindrical member 62 is tensioned by an elastic shoulder depressor cord 60, which wraps around the shoulder attachment and has ends secured proximate an anterior portion of the lower posterior rib L-bracket 32, and at a hook attachment hole 68 on a posterior portion of the lower posterior rib L-bracket 32, respectively. The lateral shoulder member 64 extends to a lateral shoulder connector 70a, which is attached to an upper arm connector 70b. The upper arm connector 70b connects the upper arm 72 via an upper arm bent clevis member 74, and utilizes a clevis pin 75 in combination with a forearm clevis member 76 to connect a forearm member 78. The forearm member 78 juts out beneath the clevis hinge to prevent hyperextension of the forearm-simulating member 78. The tendon fastener retainer ring 80, which is attached to the forearm member 78, retains the tendon fastener assembly, which is an arm elastic tendon fastener 82 that fastens arm elastic tendon member 84. The remaining end of the elastic tendon 84 fastens to the simulated upper arm 72.

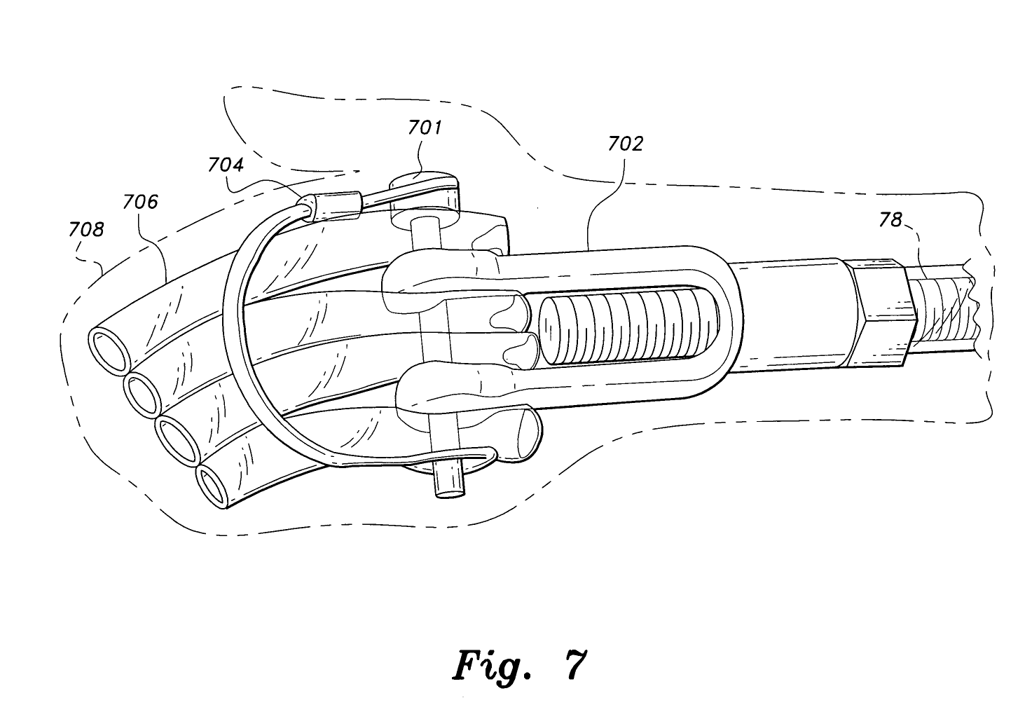

As most clearly shown in FIG. 7, the hand is comprised of a clevis 702 connected to the forearm rod or member 78. A clevis pin 701 retains a U-shaped flexion member 704 and flexible, tubular digit members 706. Foam material 708 is disposed over the hand clevis-forearm assembly to give the hand and forearm simulating members a realistic look and feel to the touch. Flexion member 704 allows flexion and extension at the wrist, while the flexible vinyl tubing 706 allows side to side or ulnar and radial deviations of the hand. The foam material 708 provides maximum flexibility to simulate the hand and fingers.

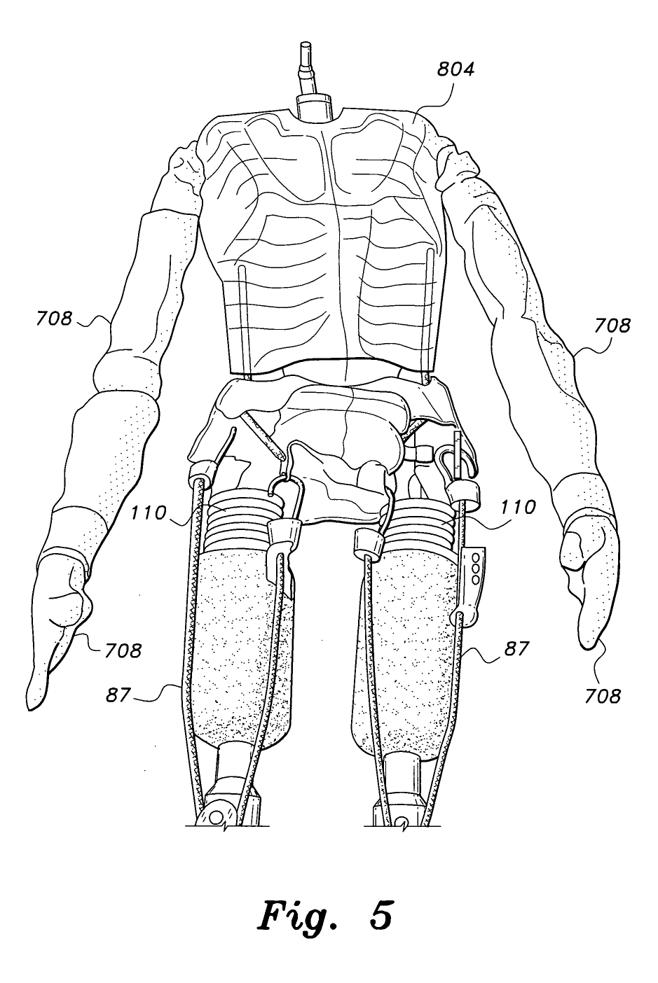

Abdominal tensioning is provided by lateral abdominal elastic cords 34 attached to and extending from superior pelvic eye screws 36. The cords 34 terminate in a hook attachment proximate the thoracolumbar L-bracket 340 on either side of the mannequin 10. As shown in FIG. 5, resilient ribcage sheets 804 are disposed over structural components from the neck to the hips. The resilient material of ribcage sheets 804 adds a dimension of reality to the feel of the mannequin 10.

There is a short upper lumbar L-bracket 46, which is interoperable with a lower lumbar flexion extension curved yoke 48 to limit pivotal motion of the lumbar portion of the mannequin 10. The posterior superior pelvic bracket 50 joins with the hip joint collar 52 and is retained by a superior pelvic eye screw nut 53. An elongate upper leg rod 555 pivotally attaches to the hip via a hip joint outside nut 333. The elongate upper leg rod 555 extends through an upper tubular foam guide 110, thigh-simulating foam 89, and a tubular thigh foam retainer 86, preferably made of plastic. The thigh-simulating foam 89 acts as a cushion to simulate muscle bulk in the thigh. A flared portion of a retainer 86 functions analogous to the inferior femoral condyle flare in an actual person. The lower end of the upper leg rod 555 terminates in a pivotal attachment to a patellar pulley 88. a posterior superior pelvic bracket 50 retains one end of a medial leg extensor elastic band 87, which extends through pulley wheel sheaves in the patellar pulley 88 and returns back up the inner thigh to be terminated at a short upper lumbar L-bracket 46. The medial leg extensor elastic band 87 simulates muscle tendons so that when the knee is flexed; tension in the extensor elastic band 87 is increased, thereby simulating knee extension in an actual person.

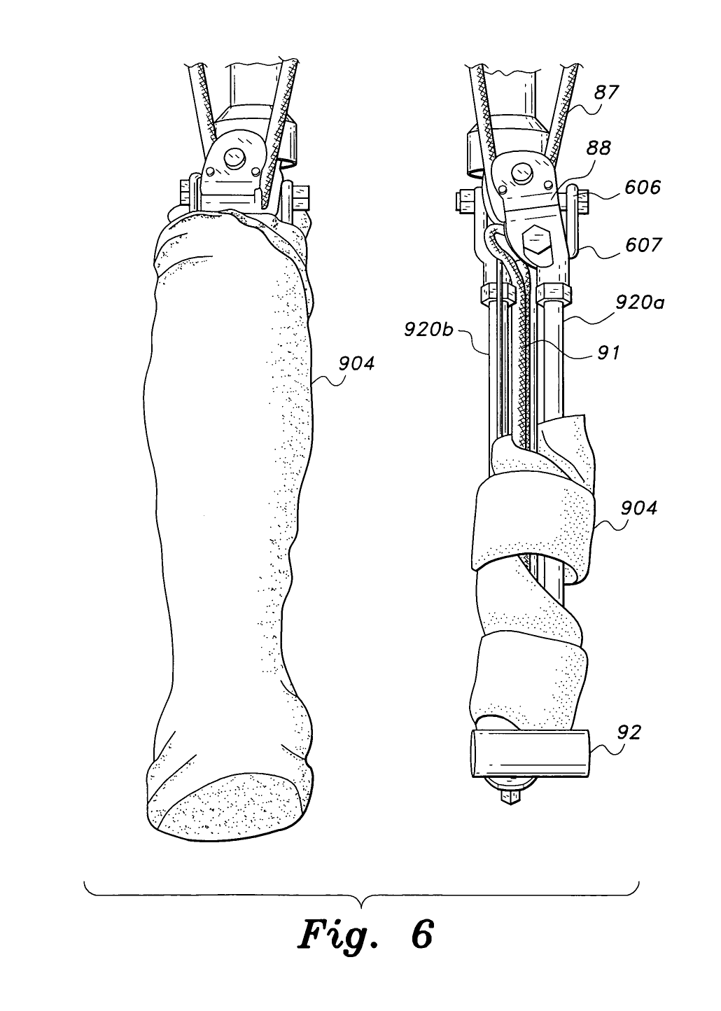

As most clearly shown in FIG. 6, the knee joint is facilitated by patellar pulley 88 and is wrapped with thigh foam 904. A bent clevis hinge joint 606 (similar to the bent clevis member 74 hinge attachment to forearm clevis member 76, shown in FIG. 3) simulates the knee joint. The upper leg rod 555 extends underneath the clevis hinge joint 606 to prevent hyperextension at the knee joint. The patellar mechanism 88 is pivotally attached to the lower knee clevis 607. Referring to FIGS. 3 and 6, an elongate fibula rod 920a is attached to and extends from the patellar pulley 88 to join a hollow T-joint foot simulator 92. Similarly, an elongate tibia rod 920b extends through an ankle range of motion limit ring 90 to join the hollow T-joint foot simulator 92 at a ball joint.

An elongate, arcuate vinyl tube shin simulator 91 is attached to the patellar pulley 88 and extends proximate the fibula rod 920 to join the foot simulator 92 at an ankle range of motion limit ring 90. The foot attachment is retained by a heel eyescrew 93. Foot-tensioning elastic band 609 hooks onto the heel eyescrew 93 to provide realistic tension when the foot is flexed up. The ankle comprises a flexible ring 90 (made of steel or aluminum, in this case) that is wrapped in vinyl tubing. The ring 90 limits the side-to-side rotation and up and down movements of the main foot. The T-shaped pipe receives the eyescrew and holds part of the flexible ring. The T-shape of the pipe 92 also simulates the ball of the foot. Foam 904 is wrapped around the assembly and simulates the toes.

It is to be understood that the present invention is not limited to the embodiment described above, but encompasses any and all embodiments within the scope of the following claims.

I claim:

1. An anthropomorphic mannequin, comprising:
an articulated skeletal frame having a plurality of rigid members forming a neck, a torso, hips, a pair of arms, a pair of legs, a pair of hands, and a pair of feet, each of the members being movably attached to the frame, the frame simulating a human skeleton;
movable joints interconnecting cooperating pairs of the rigid members, the movable joints enabling a range of motion simulating a corresponding joint in a human being;
elastic tendon members connecting the cooperating rigid members across the movable joints, the elastic tendon members providing tension in the joints when the rigid members are manipulated; and
soft, resilient material wrapped around the members to simulate skin and flesh of the human being.

2. The anthropomorphic mannequin according to claim 1, wherein:
at least one of said elastic tendon members comprises an elastic cord having a first end having a substantially spherical fastening member; and
at least one of said cooperating rigid members comprises a retainer ring, the at least one of said tendon members being threaded through the retainer ring, the first end being retained proximate said at least one cooperating rigid member via abutment of the fastening member against the retainer ring.

3. The anthropomorphic mannequin according to claim 1, wherein said plurality of rigid members further comprises first and second L-shaped members in an inverted position forming a rear portion of said torso, the first and second L-shaped members simulating an upper back-shoulder portion of said human skeleton.

4. The anthropomorphic mannequin according to claim 1, wherein said plurality of rigid members further comprises third and fourth L-shaped members forming a lower portion of said torso, the third and fourth L-shaped members having:
a long portion extending laterally across said torso's lower portion, said third and fourth L-shaped members simulating a posterior superior pelvic portion of said human skeleton;
a short portion having an end and pivot attachment points disposed at the ends of the short portion of the third and fourth L-shaped members, the pivot attachment points facilitating pivotal attachment of the lower portion of said torso to said pair of legs.

5. The anthropomorphic mannequin according to claim 1, wherein said plurality of rigid members further comprises first and second L-shaped members in an inverted position forming a rear portion of said torso, the first and second L-shaped members simulating an upper back-shoulder portion of said human skeleton, the anthropomorphic mannequin further comprising fifth and sixth L-shaped members attached to and extending downward from the first and second L-shaped members, the fifth and sixth L-shaped members forming a lower posterior rib portion of said torso.

6. The anthropomorphic mannequin according to claim 5, wherein said plurality of rigid members further comprises:
seventh and eighth L-shaped members attached to said fifth and sixth L-shaped members, the seventh and eighth L-shaped members forming a thoracolumbar portion of said torso;
ninth and tenth L-shaped members pivotally affixed to the seventh and eighth L-shaped members proximate a vertex portion of the seventh and eight L-shaped members, the ninth and tenth L-shaped members forming a thoracic upright portion of said torso;
a laterally extending posterior horizontal rib bracket, the ninth and tenth L-shaped members being anchored thereto.

7. The anthropomorphic mannequin according to claim 1, further comprising:
third and fourth L-shaped members forming a lower portion of said torso
eleventh and twelfth L-shaped members forming a short upper lumbar portion of said torso, the eleventh and twelfth L-shaped members being connected to the third and fourth L shaped posterior superior members;
a laterally extending lumbar horizontal support member;
left and right side lower lumbar support plates attached to the laterally to extending horizontal support member;
an anterior chest horizontal bracket;
an eyebolt forming a posterior thoracic ring, the eyebolt being anchored to an extender bracket attached to and extending downward from the anterior chest horizontal bracket;
an extensible cord attached to the lumbar horizontal support member, the cord extending upward through the eyebolt and longitudinally bifurcating a rear portion of said torso to simulate a spinal column of said human skeleton;
a cervical thoracic L-shaped member anchored to the laterally extending posterior horizontal rib bracket; and
an oblique angle neck extensor L-shaped member attached to a top portion of the cervical thoracic L-shaped member, the upper end of the spinal simulating extensible cord being attached to the oblique angle neck extensor L-shaped member.

8. The anthropomorphic mannequin according to claim 7, further comprising a resilient hollow tubular member anchored to and extending upward from said short upper lumbar eleventh and twelfth L-shaped members, the resilient hollow tubular member forming resilient support in the thoracic region of said torso.

9. The anthropomorphic mannequin according to claim 8, further comprising a stopping member attached to lower lumbar portion of said torso, said stopping member being interoperable with said short upper lumbar eleventh and twelfth L-shaped members to limit pivotal motion of said lumbar portion of said mannequin.

10. The anthropomorphic mannequin according to claim 1, further comprising abdominal tensioning lateral abdominal elastic cords having opposing ends anchored to said eleventh and twelfth L-shaped members and to said seventh and eighth L-shaped thoracolumbar members.

11. The anthropomorphic mannequin according to claim 1, further comprising:
a first scapulothoracic ball joint attached to the upper portion of said first inverted L-shaped upper back-shoulder member;
a first cylindrical lateral shoulder member;
a first elongate, cylindrical member extending from said first ball joint, said first elongate, cylindrical member being pivotally attached to said first cylindrical lateral shoulder member;
a second scapulothoracic ball joint attached to the upper portion of said second inverted L-shaped upper back-shoulder member;
a second cylindrical lateral shoulder member;
a second elongate, cylindrical member extending from said second ball joint, said second elongate, cylindrical member being pivotally attached to said second cylindrical lateral shoulder member;
a first elastic shoulder depressor cord wrapped around said first lateral shoulder member, ends of said first elastic shoulder depressor cord being anchored proximate an anterior portion of said first lower posterior rib L-shaped member, and proximate a posterior portion of said first lower posterior rib L-shaped member; and
a second elastic shoulder depressor cord wrapped around said second lateral shoulder member, ends of said second elastic shoulder depressor cord being anchored proximate an anterior portion of said second lower posterior rib L-shaped member, and proximate a posterior portion of said second lower posterior rib L-shaped member.

12. The anthropomorphic mannequin according to claim 1, further comprising:
a first elongate upper arm member extending from said first lateral shoulder member;
a first forearm member pivotally joined to the first elongate upper arm member;
a first forearm hyperextension stopping member disposed between said pivotally joined first arm members;
a second elongate upper arm member extending from said second lateral shoulder member;
a second forearm member pivotally joined to said second elongate upper arm member;
a second forearm hyperextension stopping member disposed between said pivotally joined second arm members;

13. The anthropomorphic mannequin according to claim 1, further comprising:
a first hand member joined to the first forearm member, the first hand member including a pivotally attached U-shaped flexion member allowing for flexion, hyperextension, ulnar and radial deviation of the first hand member with respect to said first forearm member;
flexible, resilient, tubular digit members attached to the first hand member and disposed underneath the pivotally attached U-shaped flexion member, the flexible, resilient tubular digit members allowing for resilience of the hyperextension, ulnar and radial deviations of the hand member;
a second hand member joined to the second forearm member, the second hand member including a pivotally attached U-shaped flexion member allowing for flexion, hyperextension, ulnar and radial deviation of the second hand member with respect to the second forearm member;
flexible, resilient, tubular digit members attached to the second hand member and disposed underneath the pivotally attached U-shaped flexion member, the flexible, resilient tubular digit members allowing for resilience of the hyperextension, ulnar and radial deviations of the hand member;
foam material disposed over the hand and forearm members to give the hand and forearm members a realistic look and feel to the touch.

14. The anthropomorphic mannequin according to claim 1, further comprising:
a first elongate upper leg member pivotally attached to the third L shaped posterior superior pelvic member;
a second elongate upper leg member pivotally attached to the fourth L shaped posterior superior pelvic member;
first and second upper tubular foam guides, first upper leg member being disposed through the first upper tubular foam guide, second upper leg member being disposed through the second upper tubular foam guide; and
retaining members attached to the first and second upper leg member, the retaining members securing the tubular foam guides to the upper leg members, the retaining members each having a flared portion simulating functions of an inferior femoral condyle flare in an actual person.

15. The anthropomorphic mannequin according to claim 1, further comprising: first and second patellar pulleys pivotally attached to lower end of the first and second upper leg members, respectively, the pivotal pulleys simulating a knee joint;
a patellar stop member disposed in each the patellar pulley pivotal attachments to prevent hyperextension of the simulated knee joint; and
first and second medial leg extensor elastic bands, each retained by sheaves of respective first and second patellar pulleys, the bands terminating at their respective upper lumbar L-shaped members providing tension to simulate knee extension in an actual person.

16. The anthropomorphic mannequin according to claim 1, further comprising: first and second elongate fibula rods attached to and extending from first and second patellar pulleys, respectively;
first and second elongate tibial rods attached to and extending from first and second patellar pulleys, respectively;
ends of first and second elongate tibial rods distal from tibial-patellar joints joining respective the hollow T-joint foot members; and
an ankle range of motion limit ring disposed proximate the tibial-foot member attachment for each foot member, the range of motion limit ring preventing lateral and up-down hyperextension of the foot member.

17. The anthropomorphic mannequin according to claim 16, further comprising: elongate, arcuate vinyl tube shin members attached to the patellar pulleys and extending proximate the tibial rods and joining the foot members at the ankle range of motion limit rings.

18. The anthropomorphic mannequin according to claim 16, further comprising: foot-tensioning elastic bands attached to foot members and anchored on the mannequin distal from the foot members to provide realistic tension when either the foot member is flexed up.
